(19) United States
(12) Patent Application Publication
(10) Pub. No.: US 2024/0046089 A1
(43) Pub. Date: Feb. 8, 2024

(54) ADAPTIVE LEARNING ALGORITHM

(71) Applicants: National Chengchi University, Taipei City (TW); Dinkle Enterprise Co., Ltd, New Taipei City (TW)

(72) Inventors: Rua-Huan TSAIH, Taipei City (TW); Yi-Ling LIN, Taipei City (TW); Ren-Han YANG, Taipei City (TW); Ken-Hao SHANG, Taipei City (TW); Li-Ling TSAO, Taipei City (TW)

(21) Appl. No.: 18/446,030

(22) Filed: Aug. 8, 2023

(30) Foreign Application Priority Data
Aug. 8, 2022 (TW) 111129726

(51) Int. Cl. G06N 3/08

(52) U.S. Cl. CPC G06N 3/08

(57) ABSTRACT

An adaptive learning algorithm based on a single hidden layer neural network is disclosed. The algorithm includes the following steps: generating the initial single layer neural network with the first m+1 data by the initializing module; selecting the training data for the current round and determining whether the single layer neural network of the current round can achieve the learning goal. If so, checking all the hidden nodes by the reorganizing module and performing the deleting action to the hidden nodes to avoid the overfitting problems. If not, adjusting the weight parameters by the matching module and determining whether the adjusted neural network is acceptable, adding three new hidden nodes by the cramming module to obtain the acceptable neural network. The hidden nodes of the updated network are checked by the reorganization module to avoid the overfitting. The training process continues adding new data until all training data is trained.

### CROSS-REFERENCE TO RELATED APPLICATION

This application claims the benefit of Taiwan Patent Application No. 111129726, filed on Aug. 8, 2022, the disclosure of which is incorporated by reference herein in its entirety.

### BACKGROUND OF THE INVENTION

### 1. Field of the Invention

The present invention relates to an adaptive learning algorithm developed based on a single hidden layer neural network, and more particularly, an adaptive learning algorithm using an adaptive single hidden layer neural network to predict the consumption of industrial raw materials.

### 2. Description of the Related Art

In the past, manufacturers evaluate raw material procurement mostly based on experiences. However, different period, different part numbers, and different raw material types, cannot be determined using a single estimation criterion. Therefore, the results obtained based on experiences are often impossible to accurately and reasonably predict the reserve quantity. Manufacturers have difficulties in effectively achieving the demand goals, such as storing appropriate inventory, increasing inventory turnover, and reducing business costs.

To solve the above problems, neural network models have been proven to be effective in dealing with nonlinear data characteristics. However, this type of model is more sensitive to the adjustment of model hyperparameters, and it is prone to have the problems of gradient disappearance and overfitting when learning data with complex fitting functions. Gradient disappearance means that the model adjustment parameters use gradient descent method and backpropagation to train the artificial neural network. The gradient value is approaching to zero so the weight cannot be effectively updated, and even the training of the neural network cannot be continued. Overfitting refers to a phenomenon in which a model fits a particular set of data too precisely that the model does not fit well to other data or predict future observations. In the field of artificial intelligence, these phenomena can be attributed to the presence of too many parameters or large parameter values in the model.

In view of the above, the existing calculation method still has its limitations in prediction, and it is difficult to ensure the accuracy of its prediction results. In this regard, the inventors of the present invention develop and design an adaptive learning algorithm to improve the deficiencies of the existing technology, thereby enhancing the implementation and utilization in the industry.

### SUMMARY OF THE INVENTION

In view of the above-mentioned problems in the prior art, the purpose of the present invention is to provide an adaptive learning algorithm to solve the problems of gradient disappearance and overfitting in the network model of the prior art.

According to one object of the present invention, an adaptive learning algorithm is provided and includes the following steps: S1: providing all training data by an input module; S2: performing a linear regression operation on first m+1 training data by an initialization module to establish an initial single-layer neural network, wherein the initial single-layer neural network includes an initial weight parameter; S3: selecting a quantity of training data corresponding to each round by a screening module using a selection mechanism which substitutes all the training data into an acceptable single-layer neural network obtained in a previous round for prediction, calculates a residual sum of squares between an actual value and a predicted value of each training data, performs sorting, and selects a corresponding quantity of training data which is sorted into an ascending order; S4: substituting the selected training data into the initial single-layer neural network by the screening module, and determining whether a learning goal of the training data has been achieved, if yes, accepting the initial single-layer neural network and entering step S7, if no, continuing to step S5; S5: storing a current neural network weight parameter, adjusting the current neural network weight parameter by an adjustment module, and determining whether the adjusted neural network is in an acceptable state, and if the adjusted neural network is in an acceptable state, entering step S7, if not, continuing to step S6; S6: restoring to the neural network weight parameter stored in step S5, and adding three hidden nodes by a cramming module to obtain a newly accepted single-layer neural network as an acceptable single-layer neural network and enter step S7; S7: accessing the acceptable single-layer neural network and a weight parameter by a reorganization module to check all hidden nodes in the network and deleting invalid nodes; S8: returning to step S3 in which the acceptable single-layer neural network is used as an acceptable initial single-layer neural network for a next round, and adding a quantity of training data for the next stage of training until all the training data are trained.

Preferably, the initial single-layer neural network may include a plurality of input nodes, a hidden node and an output node, and the weight parameter includes a weight value between the input nodes and the hidden node, a deviation value of the hidden node, a weight value between the hidden node and the output node, and a deviation value of the output node.

Preferably, the weight value between the hidden node and the output node of the initial single-layer neural network is 1, and the deviation value of the output node is a minimum value of the actual value in an initial data.

Preferably, the adjustment module may set an adjustment learning rate and adjusts the initial weight parameter according to the adjustment learning rate to obtain an adjustment weight parameter, when a loss function value of the adjustment weight parameter is less than a loss function value of the initial weight parameter, determining whether a sum of squares between a residual value is less than a preset target value, if yes, using the acceptable single-layer neural network and the adjustment weight parameter and entering step S7, if no, increasing the adjustment learning rate to re-acquire the adjustment weight parameter until a predetermined quantity of training times is reached.

Preferably, the adjustment learning rate may be increased to 1.2 times.

Preferably, when the loss function value of the adjustment weight parameter is not less than the loss function value of the initial weight parameter, determining whether the adjustment learning rate is greater than an adjustment learning rate threshold, if yes, reducing the adjustment learning rate to re-acquire the adjustment weight parameter, if no, entering step S6.

Preferably, the adjustment learning rate may be reduced to 0.7 times.

Preferably, the reorganization module executes a regularization module to adjust the weight parameter, and deletes one of all hidden nodes in each operation, and then a determining module determines whether the reorganized single-layer neural network after deleting nodes is acceptable, if yes, the deleted nodes are regarded as the invalid nodes, and the next node is determined after deleting the nodes, if not, the nodes are added back again, and then determining whether the next node is an invalid node.

Preferably, an output value of the output node may be a forecast of raw material consumption after a predetermined period.

Preferably, an input variable of the input nodes may include raw material consumption, average consumption, raw material part number, raw material group classification, and usage period or a combination thereof during different periods.

Based on the above, the adaptive learning algorithm according to the present invention may have one or more of the following advantages:
(1) This adaptive learning algorithm can employ adaptive adjustment to solve the problem of gradient disappearance and overfitting encountered by the single hidden layer feedforward neural network, thereby improving the operation process of the algorithm and inhibiting the above problems from affecting the training and testing process.
(2) This adaptive learning algorithm can adjust parameter weights and hidden nodes to establish a single-layer neural network that meets the learning goal, thereby improving the accuracy of prediction results and reducing the probability of misjudgment.
(3) This adaptive learning algorithm can be applied to predict the consumption of raw materials in different periods, increase the quantity and utilization rate of raw material inventory, and reduce production costs and increase manufacturing profits.

### BRIEF DESCRIPTION OF THE DRAWINGS

To make the technical features, content, and advantages of the present disclosure and the achievable effects more obvious, the present disclosure is described in detail in conjunction with the accompany drawings and in the form of expressions of the embodiments as follows:

FIG. 1 is a flow chart of steps of the adaptive learning algorithm in accordance with an embodiment of the present disclosure.

FIG. 2 is an operation flow chart of an initialization module in accordance with an embodiment of the present disclosure.

FIG. 3 is an operation flowchart of a calibration module in accordance with an embodiment of the present disclosure.

FIG. 4 is an operation flowchart of a reorganization module in accordance with an embodiment of the present disclosure.

FIG. 5 is a module architecture diagram of an adaptive learning algorithm in accordance with an embodiment of the present disclosure.

### DETAILED DESCRIPTION OF THE PREFERRED EMBODIMENTS

To facilitate the review of the technical features, contents, advantages, and achievable effects of the present disclosure, the embodiments together with the drawings are described in detail as follows. However, the drawings are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

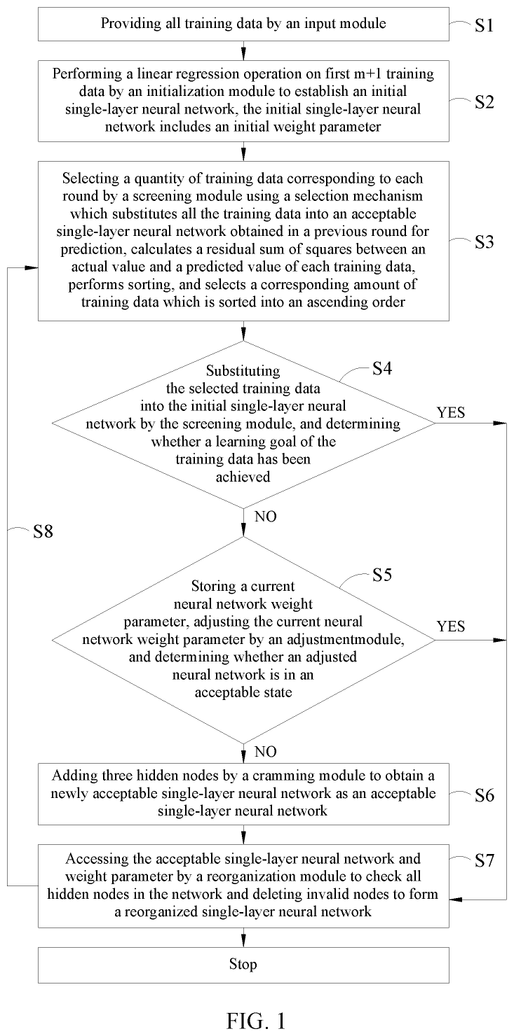

Please refer to FIG. 1, which is a flow chart of steps of the adaptive learning algorithm in accordance with an embodiment of the present disclosure. As shown in FIG. 1, the adaptive learning algorithm includes the following steps (S1—S8):

Step S1: providing all the training data by an input module. The adaptive learning algorithm can be used in the production number forecast after different periods to assist the production unit to estimate the raw material consumption required for future production, thereby planning the production schedule and raw material procurement in the early stage to reduce costs and expenditures and increase profitability. In the present embodiment, the consumption of copper material after 2 months is used as the estimated target, the historical data of production and procurement are collected and divided into training data and test data according to a predetermined ratio. The copper consumption in each month, the average copper consumption in six months, the part number of copper, the group classification of copper, the estimated months, the estimated copper consumption in this month and the next month are used as input variables, the estimated copper consumption after 2 months is used as the output value, and the training data is input from the input module to build the prediction model.

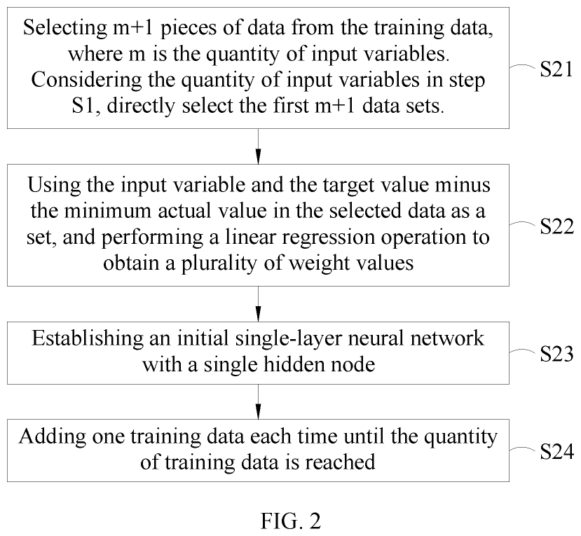

Step S2: performing a linear regression operation on first m+1 training data by an initialization module to establish an initial single-layer neural network. The initial single-layer neural network includes an initial weight parameter. In order to input the first m+1 training data, an initial single-layer neural network is first established by the initialization module. Please refer to FIG. 2 for the method of establishing the initialization single-layer neural network, which is an operation flow chart of an initialization module in accordance with an embodiment of the present disclosure. As shown in FIG. 2, the operation flow of the initialization module includes the following steps (S21—S24).

Step S21: selecting m+1 pieces of data from the training data, where m is the quantity of input variables. Considering the quantity of input variables in step S1, directly select the first m+1 data sets. For example, when m=10, directly select the first 11 data sets.

Step S22: using the input variable and the target value minus the minimum actual value in the selected data as a set, and performing a linear regression operation to obtain a plurality of weight values. The equation of linear regression is shown in formula (1):

$${w}_{0} + {\sum }_{j = 1}^{m} {w}_{j} {x}_{j}^{c} = {y}^{c} - {min}_{u ∈ I ( m + 1 )} {y}^{u} ∀ c ∈ I ( m + 1 ) \qquad ( 1 )$$

wherein w₀ is a deviation value of the regression equation, w₁ is a weight corresponding to the input variable xⱼ^{c}, y^{c} is a target value corresponding to the c^{th} data, and xⱼ^{c} is a j^{th} input variable corresponding to the c^{th} data,

$${min}_{u ∈ I ( m + 1 )} {y}^{u}$$

a minimum target value in the set.

Step S23: establishing an initial single-layer neural network with a single hidden node. The initial single-layer neural network may include a plurality of input nodes, a hidden node, and an output node. The weight parameter w includes a weight value between the input nodes and the hidden node, a deviation value of the hidden node, a weight value between the hidden node and the output node, and the deviation value of the output node. In the present embodiment, the weight value between the input nodes and the hidden node is wⱼ, the deviation value of hidden nodes is w₀, the weight value between the hidden node and the output node is 1, and the deviation value of output nodes is

$${min}_{u ∈ I ( m + 1 )} {y}^{u} .$$

In this initial single-layer neural network, the residual sum of squares is 0 for the first m+1 sets of data.

In the present embodiment, the single-layer neural network has a single output node. The output value of the output node can be expressed by formula (2). The activation function of the neural network can use the linear rectification function (Rectified Linear Unit, ReLU), as shown in formula (3).

ƒ(x^{c},w)≡w₀^{o}+Σᵢ₌₁^{p}wᵢ^{o}αᵢ^{c} (2)

αᵢ^{c}≡ReLU(w_{i,0}^{H}+Σⱼ₌₁^{m}w_{i,j}^{H}xⱼ^{c}) (3)

Step S24: adding one training data each time until the quantity of training data is reached, substituting the initial single-layer neural network into the subsequent steps, and continuing to increase the training data until the training procedure for all training data is completed.

Step S3: selecting the quantity of training data corresponding to each round by a screening module using a selection mechanism. The selection mechanism is as follows: substituting all the training data into the acceptable single-layer neural network obtained in the previous round for prediction, and then calculating the sum of the residual squares between the actual value and the predicted value, performs sorting, and selecting the corresponding quantity of training data sorted into an ascending order (i.e. from small to large). In each round of training, all the training data are predicted by the acceptable single-layer neural network obtained in the previous round to obtain the predicted value, and sorted according to the difference between the predicted value and the actual value into an ascending order (i.e. from small to large), and then a quantity of training data required for this round is selected for training. In the present embodiment, the training process is to increase a quantity of training data each time. The screening process by the screening module is to ensure that approximate data is used for training first. Therefore, a sorting according the sum of squared residuals of the actual value and predicted value of the training data is performed in the process, and then select a predetermined quantity of data as the selected training data which is sorted from small to large.

Step S4: substituting the selected training data into the initial single-layer neural network by the screening module, and determining whether a learning goal of the training data has been achieved, if yes, accepting the initial single-layer neural network and entering step S7, if no, continuing to step S5. In the training stage of each round, the selected quantity of training data will be substituted into the acceptable single-layer neural network obtained in the previous round to determine whether the selected training data can meet the learning goal. In the present embodiment, by determining whether the residual error between the predicted value generated by substituting the selected training data and the input actual value can be less than the preset target value is used to determine whether the learning goal can be achieved. If the learning goal can be achieved, the single-layer neural network and the initial weight parameter is accepted, and then the reorganization module of step S7 is entered to determine whether there are invalid hidden nodes. On the contrary, if the learning goal cannot be achieved, continuing to S5 to adjust the weight parameters by the adjustment module.

Step S5: storing a current neural network weight parameter, adjusting the current neural network weight parameter by an adjustment module, and determining whether the adjusted neural network is in an acceptable state, and if the adjusted neural network is in an acceptable state, entering step S7, if not, continuing to step S6. In the case that the above input and selected training data cannot meet the learning goal, the initial weight parameter is adjusted by the adjustment module to adjust the weight parameters, such that the single-layer neural network meets the learning goal and enters the reorganization module of step S7 to determine whether there are invalid hidden nodes. If the weight parameter that meets the target cannot be obtained by the adjustment, it is regarded as an unacceptable single-layer neural network. Firstly, the weight parameters stored in step S5 will be restored, and then step S6 is used to add the hidden node to the current single-layer neural network.

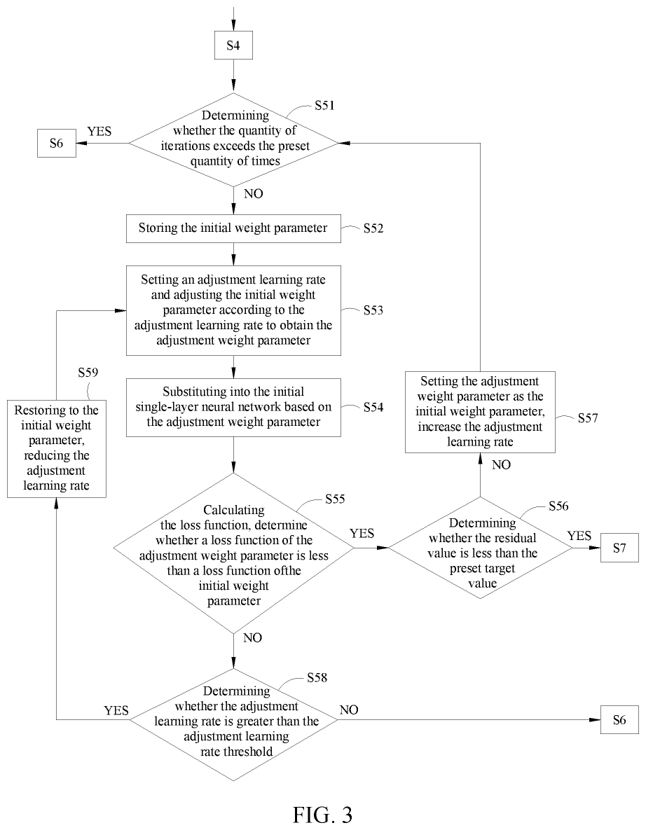

please refer to FIG. 3 for the detailed method of adjusting weight parameters, which is an operation flowchart of a calibration module in accordance with an embodiment of the present disclosure. As shown in FIG. 3, the operation procedures of the adjustment module include the following steps (S51-S59).

Step S51: determining whether the quantity of iterations exceeds the preset quantity of times. If yes, it is regarded as an unacceptable single-layer neural network, and proceed to step S6. If no, continuing to step S52. The initial single-layer neural network and the initial weight parameter that have not reached the learning goal in the aforementioned step S4 are inputted. Firstly, determining whether the quantity of training iterations exceeds the preset quantity, for example, it is set to 10,000. The purpose of setting the preset quantity of times is to avoid the waste of computing resources and computing time caused by the endless update of the training process. Therefore, when the preset quantity of times is not reached, proceed to the subsequent step S52. However, if the preset quantity of times still is reached but is still fails to meet the learning goal, it will be regarded as an unacceptable single-layer neural network, and enter step S6

Step S52: storing the initial weight parameter. Before performing an adjustment, the adjustment module first stores the initial weight parameter, and the update of the initial weight parameter will be decided according to the adjustment result.

Step S53: setting an adjustment learning rate and adjusting the initial weight parameter according to the adjustment learning rate to obtain the adjustment weight parameter. A backward operation is performed, in which the initial weight parameter is adjusted by the preset adjustment learning rate, so as to obtain an adjusted adjustment weight parameter.

Step S54: substituting into the initial single-layer neural network based on the adjustment weight parameter. A forward operation is re-performed, in which a new adjustment weight parameters is substituted, thereby re-substituting the training data into the initial single-layer neural network, and then further determining whether the adjusted parameters meet the adjustment regulation.

Step S55: calculating the loss function, determine whether a loss function of the adjustment weight parameter is less than a loss function of the initial weight parameter, if yes, entering step S56, if not, entering step S58. The method of determining whether the adjusted parameters meet the regulation is performed by calculating a loss function. In the present embodiment, the loss function can be expressed by formula (4).

$${E}_{n} ( w ) ≡ \frac{1}{n} {\sum }_{c = 1}^{n} {( {e}^{c} )}^{2} \qquad ( 4 )$$

wherein w is the weight parameter, n is the quantity of training data, and e^{c} is the residual value between the predicted value and the actual value. By comparing the loss function of the initial weight parameter and the loss function of the adjustment weight parameter, it is determined whether the adjusted parameter meets the adjustment regulation. If the loss function of the adjustment weight parameter is less than the loss function of the initial weight parameter, it is deemed that the adjustment regulation is met, and then entering step S56 to further confirm whether the learning goal can be met after the adjustment. On the contrary, if the loss function of the adjustment weight parameter is greater than the loss function of the initial weight parameter, it is deemed that the adjustment exceeds the specification, and then entering step S58 to further determine whether to continue the adjustment.

Step S56: determining whether the residual value is less than the preset target value, if yes, accepting the adjustment weight parameter and proceeding to step S7, if no, proceeding to step S57. After meeting the adjustment regulation in the previous step S55, calculating whether the residual value between the predicted value and the actual value is less than the preset target value, if yes, it is determined that the adjustment has reached the demand, accepting the adjusted single-layer neural network and entering step S7, on the other hand, if the learning goal still cannot be achieved, entering step S57 to adjust the weight parameter again.

Step S57: setting the adjustment weight parameter as the initial weight parameter, increase the adjustment learning rate, return to step S51, and perform the next parameter adjustment. Because the adjustment weight parameter meets the adjustment regulation, the adjustment weight parameter is first updated to the new initial weight parameter, and re-enter step S51 for the next adjustment. At the same time, the adjustment learning rate can be increased, for example, adjusted to 1.2 times the original learning rate coefficient and increase the adjustment range to improve the adjustment efficiency. After the quantity of adjustments is confirmed in step S51, the next parameter adjustment is performed with the adjusted adjustment learning rate.

Step S58: determining whether the adjustment learning rate is greater than the adjustment learning rate threshold, if yes, proceed to step S59, if not, it is regarded as an unacceptable single-layer neural network, and proceed to step S6. In the case that the previous step S55 fails to meet the adjustment regulation, it is determined whether the adjustment learning rate is greater than the adjustment learning rate threshold, if yes, entering step S59 to perform re-adjustment, if no, it is regarded as an unacceptable single-layer neural network, entering step S6.

Step S59: restoring to the initial weight parameter, reducing the adjustment learning rate, and returning to step S53 for parameter adjustment. The adjustment learning rate is reduced, for example, to 0.7 times the original value, return to step S53 to perform the backward operation, and proceed to the process of adjusting the parameters again to obtain a new adjustment weight parameter.

Step S6: restoring to the weight parameters stored in step S5, adding three hidden nodes through the cramming module to obtain the newly accepted single-layer neural network as an acceptable single-layer neural network, and entering step S7.

The operation process of the cramming module includes using orientation algorithm to establish a vector y, which satisfies formula (5), and selects a small number so as to satisfy formula (6). Then add three new hidden nodes to the single-layer neural network, so that the weights of the new hidden nodes are shown in formula (7) to formula (9), so that the residual value is less than the learning goal of the preset target value.

$${γ}^{T} ( {x}^{c} - {x}^{κ} ) \neq 0 ∀ c ∈ I ( n ) - \{ κ \} \qquad ( 5 )$$

$$( ζ + {γ}^{T} ( {x}^{c} - {x}^{κ} ) ) * ( ζ - {γ}^{T} ( {x}^{c} - {x}^{κ} ) ) < 0 ∀ c ∈ I ( n ) - \{ κ \} \qquad ( 6 )$$

$${w}_{p - 2}^{H} = γ , {w}_{p - 2 , 0}^{H} = ζ - {γ}^{T} {x}^{κ} , {w}_{p - 2}^{o} = \frac{{y}^{κ} - {w}_{0}^{o} - {\sum }_{i = 1}^{p - 3} {w}_{i}^{o} {a}_{i}^{κ}}{ζ} \qquad ( 7 )$$

$${w}_{p - 1}^{H} = γ , {w}_{p - 1 , 0}^{H} = - {γ}^{T} {x}^{κ} , {w}_{p - 1}^{o} = \frac{- 2 ( {y}^{κ} - {w}_{0}^{o} - {\sum }_{i = 1}^{p - 3} {w}_{i}^{o} {a}_{i}^{κ} )}{ζ} \qquad ( 8 )$$

$${w}_{p}^{H} = γ , {w}_{p , 0}^{H} = - ζ - {γ}^{T} {x}^{κ} , {w}_{p}^{o} = \frac{{y}^{κ} - {w}_{0}^{o} - {\sum }_{i = 1}^{p - 3} {w}_{i}^{o} {a}_{i}^{κ}}{ζ} \qquad ( 9 )$$

Step S7: checking all hidden nodes in the network and deleting invalid nodes by accessing acceptable single-layer neural network and weight parameters by the reorganization module. In this step, regardless of it is an acceptable single-layer neural network obtained in steps S4 and S5, or an acceptable single-layer neural network obtained after adding hidden nodes in step S6, the hidden nodes in the network can be inspected by the reorganization module, thereby deleting the invalid or meaningless nodes.

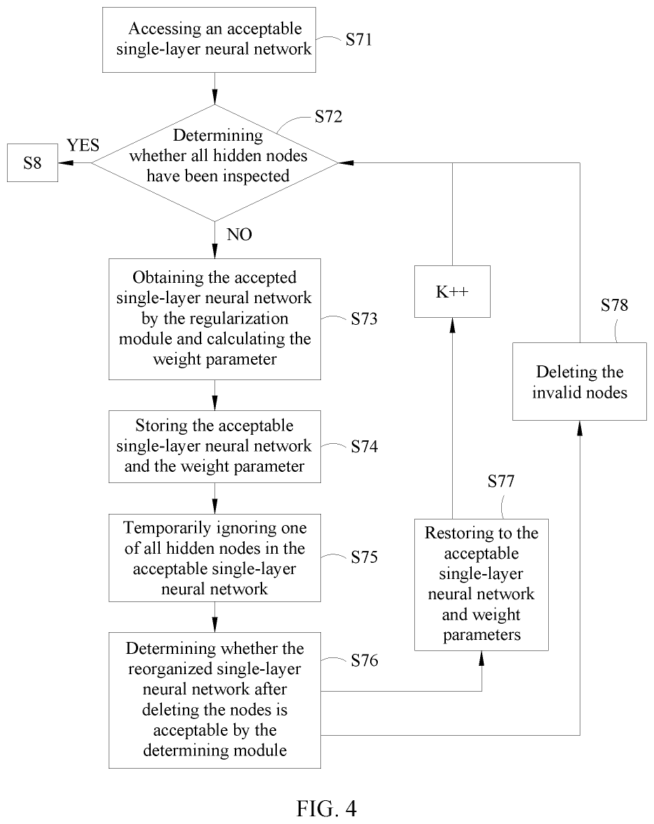

Please refer to FIG. 4 for a detailed method of inspecting hidden nodes, which is an operation flowchart of a reorganization module in accordance with an embodiment of the present disclosure. As shown in FIG. 4, the operation flow of the reorganization module includes the following steps (S71-S78).

Step S71: accessing an acceptable single-layer neural network. As mentioned above, regardless of it is the acceptable single-layer neural network accepted by step S4 and step S5, or the acceptable single-layer neural network obtained after adding hidden nodes in step S6, all of them are single-layer neural networks that meet the learning goal.

Step S72: determining whether all hidden nodes have been inspected, if yes, proceeding to step S8, if no, proceeding to step S73. In the present embodiment, hidden nodes are checked one by one, in other words, only one hidden node is ignored in each operation until all hidden nodes are checked. Therefore, when performing hidden node inspection, continue to step S73. If the quantity of checked nodes has reached the quantity of all hidden nodes, the operation of the reorganizing module is completed, and then enter step S8.

Step S73: obtaining the accepted single-layer neural network by the regularization module and calculating the weight parameter. The weight parameter of the accessed single-layer neural network is calculated by the normalization module. The calculation method of the normalization module is similar to the calculation method of the adjustment module. Please refer to the content of the above-mentioned embodiments, and the same content thereof will not be repeated herein. The difference from the tuning module is that the loss function can be expressed by formula (10).

$${E}_{n} ( w ) ≡ \frac{1}{n} {\sum }_{c = 1}^{n} {( {e}^{c} )}^{2} + λ {‖ w ‖}^{2} \qquad ( 10 )$$

When the calculation of the loss function meets the adjustment regulation, it is also determined again whether the learning goal is met. If yes, further increase the adjustment learning rate to adjust the weight parameter. If no, restore the weight parameter again. When the loss function calculation does not meet the adjustment regulation, determine whether the adjustment learning rate is greater than the adjustment learning rate threshold, if yes, the adjustment learning rate is further reduced to adjust the weight parameters, if no, the weight parameter is stored again.

Step S74: storing the acceptable single-layer neural network and the weight parameter. The single-layer neural network and weight parameters obtained by the normalization module are stored.

Step S75: temporarily ignoring one of all hidden nodes in the acceptable single-layer neural network. The single-layer neural network is updated to obtain a reorganized single-layer neural network by temporarily ignoring a hidden neuron in an acceptable single-layer neural network.

Step S76: determining whether the reorganized single-layer neural network after deleting the nodes is acceptable by the determining module, if not acceptable, entering step S77, if acceptable, entering step S78. In the present embodiment, the determining module determines whether the reorganized single-layer neural network is an acceptable single-layer neural network by the same adjustment module as the previous embodiment, if yes, entering step S78, if no, entering step S77.

Step S77: restoring to the acceptable single-layer neural network and weight parameters and returning to step S72. Because the reorganized single-layer neural network is not acceptable, the ignored hidden nodes are added back, i.e., the original stored acceptable single-layer neural network and weight parameters are restored. After returning to step S72, the next hidden node is deleted to determine whether it is an invalid node.

Step S78: deleting the invalid nodes and entering step S72 by the reorganized single-layer neural network. Because the reorganized single-layer neural network is acceptable, the invalid neuron is deleted, and returns to step S72 by the single-layer neural network after deleting the neuron to inspect the next hidden node.

Step S8: returning to step S3 to use the acceptable single-layer neural network as the acceptable initial single-layer neural network for a next round, and adding one training data for the next stage of training until all the training data are completed training. After the reorganized single-layer neural network is obtained by the reorganized module, returning to step S3, setting the acceptable single-layer neural network as the initial single-layer neural network of this step, and then adding one training data, re-performing the aforementioned training process until the predetermined quantity that is trained in the training phase reaches the quantity of training data, then stop the training process.

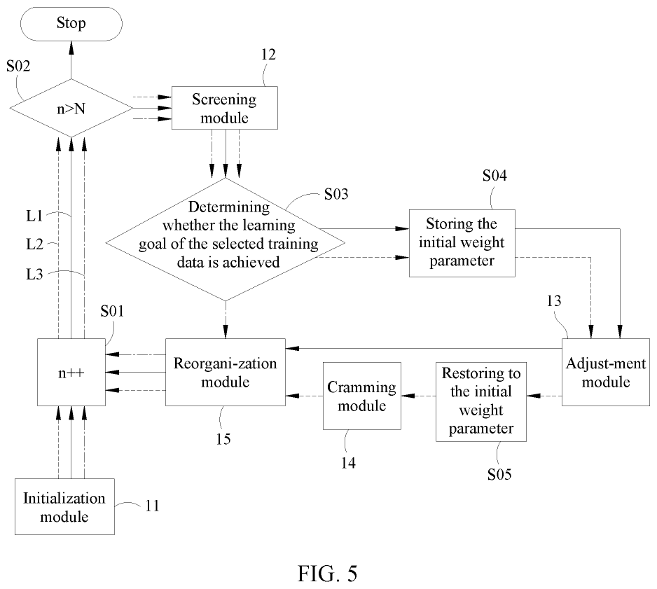

Please refer to FIG. 5, which is a module architecture diagram of an adaptive learning algorithm of an embodiment in accordance with the present disclosure. As shown in FIG. 5, the architecture of the adaptive learning algorithm includes an initialization module 11, a screening module 12, an adjustment module 13, a cramming module 14, and a reorganization module 15. These modules can use a processor of a computer or a server to execute the corresponding control instructions, and can access the data stored in the memory to carry out calculation processes of each module. According to the above-mentioned architecture of the modules, the adaptive learning algorithm of the present embodiment may include three learning paths: a thinking path L1, a cramming path L2 and a reorganization path L3.

Firstly, inputting a plurality of training data through an input interface, selecting an initial data from the training data by the initialization module 11, and performing a linear regression operation on the initial data to establish an initial single-layer neural network. The initial single-layer neural network includes an initial weight parameter. After the initial single-layer neural network and the initial weight parameter are obtained, inputting the training data for training. In the present embodiment, each stage of training is performed by adding a quantity of data, and the neural network learns through one of the following three paths each time: a thinking path L1, a cramming path L2, and a reorganization path L3. After each round of learning, a new training data will be added (step S01) until the system determines that the quantity of inputted training data reaches the quantity of the data (step S02), then the adaptive learning algorithm is stopped. In the present embodiment, please refer to the description of the foregoing embodiments for the operation method of each module, the same content thereof will not be repeated herein.

In the training process of each stage, selecting a quantity of training data that meets the predetermined quantity of this stage by the screening module 12. The selection method is as follows: substituting the training data into the initial single-layer neural network to calculate a residual sum of squares between an actual value and a predicted value of each of the quantity of training data, performing sorting, and selecting a predetermined quantity of training data which is sorted into an ascending order. Then, substituting the selected training data into the initial single-layer neural network to determine whether the learning goal of the selected training data is achieved (step S03). The above steps belong to the same processing flow for different processing paths, but, the thinking path L1, the cramming path L2, or the reorganization path L3 will modify the architecture of the single hidden layer neural network by different operation methods, based on the results of determining the learning goal.

When the learning goal of the selected training data does not reach the preset target value, the adaptive algorithm will try to adjust the weight parameter, so that the single-layer neural network becomes an acceptable network after adjusting the weight parameters. In the present embodiment, both the thinking path L1 and the cramming path L2 will first store the initial weight parameter (step S04), and then adjust the weight parameters by the adjustment module 13. If the adjustment of the adjustment module 13 does not violate the adjustment regulation, then further confirm whether the adjustment can meet the learning goal. If the learning goal still cannot be met, update the adjustment learning rate to adjust the parameters again until the quantity of adjustments reaches the preset quantity. However, if the learning goal is met after the adjustment, the adjusted adjustment weight parameter and the corresponding single-layer neural network are regarded as an acceptable neural network architecture, i.e., enter the reorganization module 15 through the thinking path L1. On the other hand, if the adjustment of the adjustment module 13 does not meet the adjustment regulation, then further consider whether the adjustment learning rate is less than the preset target value, if yes, update the adjustment learning rate to re-adjust the parameter, if no, it is considered as an unacceptable single-layer neural network. In the adjustment module 13, the unacceptable single-layer neural network will first restore to the initial weight parameter through the cramming path L2 (step S05), and then add new hidden nodes by the cramming module 14, so that the updated single-layer neural network having new nodes can meet the learning goal and becomes an acceptable network to enter the reorganization module 15.

For the reorganization module 15, regardless of it is the initial single-layer neural network entered through the reorganization path L3, the single-layer neural network with the weight parameters adjusted by the adjustment module 13, or the single-layer neural network with added hidden nodes, each is a single-layer neural network that meets the learning goal. In the reorganization module 15, the hidden nodes in the network architecture are inspected to determine whether there are invalid or useless nodes. The determination method of the present embodiment is to temporarily delete the neurons of the hidden layer in sequence, and confirm whether the architecture of the single-layer neural network is acceptable by a training module, if it is acceptable, it means that the deletion of nodes does not affect the network. Therefore, the deleted node is regarded as an invalid node to be deleted, and then an acceptable single-layer neural network is obtained. However, if it is unacceptable, it means that the deleted node will significantly affect the network prediction results, and it should not be deleted, so the deleted node will be added back, and then the next hidden node will be checked until all hidden nodes are checked.

By the automatic adjustment of the above weight parameters and hidden nodes, the adaptive learning algorithm of the present embodiment can solve the problems of gradient disappearance and overfitting in the existing algorithm, and can effectively improve the actual prediction effect. After actually training the consumption of mineral raw materials, the prediction model of the adaptive learning algorithm of the present embodiment can have an accuracy rate of 90.11% in the training stage, and an accuracy rate of 84.05% in the testing stage. Compared with the 70% accuracy rate of the existing artificial intelligence neural network, the accuracy rate of the prediction is indeed significantly increased.

In this application, including the definitions above, the term “module” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The algorithm and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The above description is merely illustrative rather than restrictive. Any equivalent modifications or alterations without departing from the spirit and scope of the present disclosure are intended to be included in the following claims.

What is claimed is:

1. An adaptive learning algorithm, comprising the following steps:
S1: providing all training data by an input module;
S2: performing a linear regression operation on first m+1 training data by an initialization module to establish an initial single-layer neural network, wherein the initial single-layer neural network comprises an initial weight parameter;
S3: selecting a quantity of training data corresponding to each round by a screening module using a selection mechanism which substitutes all the training data into an acceptable single-layer neural network obtained in a previous round for prediction, calculates a residual sum of squares between an actual value and a predicted value of each training data, performs sorting, and selects a corresponding quantity of training data which is sorted into an ascending order;
S4: substituting the selected training data into the initial single-layer neural network by the screening module, and determining whether a learning goal of the training data has been achieved, if yes, accepting the initial single-layer neural network and entering step S7, if no, continuing to step S5;
S5: storing a current neural network weight parameter, adjusting the current neural network weight parameter by an adjustment module, and determining whether the adjusted neural network is in an acceptable state, and if the adjusted neural network is in an acceptable state, entering step S7, if not, continuing to step S6;
S6: restoring to the current neural network weight parameter stored in step S5, and adding three hidden nodes by a cramming module to obtain a newly accepted single-layer neural network as an acceptable single-layer neural network and enter step S7;
S7: accessing the acceptable single-layer neural network and a weight parameter by a reorganization module to check all hidden nodes in the network and deleting invalid nodes;
S8: returning to step S3 in which the acceptable single-layer neural network is used as an acceptable initial single-layer neural network for a next round, and adding a quantity of training data for the next stage of training until all the training data are trained.

2. The adaptive learning algorithm of claim 1, wherein the initial single-layer neural network comprises a plurality of input nodes, a hidden node and an output node, and the weight parameter comprises a weight value between the input nodes and the hidden node, a deviation value of the hidden node, a weight value between the hidden node and the output node, and a deviation value of the output node.

3. The adaptive learning algorithm of claim 2, wherein the weight value between the hidden node and the output node of the initial single-layer neural network is 1, and the deviation value of the output node is a minimum value of the actual value in an initial data.

4. The adaptive learning algorithm of claim 1, wherein the adjustment module sets an adjustment learning rate and adjusts the initial weight parameter according to the adjustment learning rate to obtain an adjustment weight parameter, when a loss function value of the adjustment weight parameter is less than a loss function value of the initial weight parameter, determining whether a residual value is less than a preset target value, if yes, using the acceptable single-layer neural network and the adjustment weight parameter and entering step S7, if no, increasing the adjustment learning rate to re-acquire the adjustment weight parameter until a predetermined quantity of training times is reached.

5. The adaptive learning algorithm of claim 4, wherein the adjustment learning rate is increased to 1.2 times.

6. The adaptive learning algorithm of claim 4, wherein when the loss function value of the adjustment weight parameter is not less than the loss function value of the initial weight parameter, determining whether the adjustment learning rate is greater than an adjustment learning rate threshold, if yes, reducing the adjustment learning rate to re-acquire the adjustment weight parameter, if no, entering step S6.

7. The adaptive learning algorithm of claim 6, wherein the adjustment learning rate is reduced to 0.7 times.

8. The adaptive learning algorithm of claim 1, wherein the reorganization module executes a regularization module to adjust the weight parameter, and deletes one of all hidden nodes in each operation, and then a determining module determines whether the reorganized single-layer neural network after deleting nodes is acceptable, if yes, the deleted nodes are regarded as the invalid nodes, and the next node is determined after deleting the nodes, if not, the nodes are added back again, and then determining whether the next node is an invalid node.

9. The adaptive learning algorithm of claim 2, wherein an output value of the output node is a forecast of raw material consumption after a predetermined period.

10. The adaptive learning algorithm of claim 9, wherein an input variable of the input nodes comprise raw material consumption, average consumption, raw material part number, raw material group classification, and usage period or a combination thereof during different periods.
